(19) United States
(12) Patent Application Publication
(10) Pub. No.: US 2011/0033663 A1
(43) Pub. Date: Feb. 10, 2011

(54) SUPERHYDROPHOBIC AND SUPERHYDROPHILIC MATERIALS, SURFACES AND METHODS

(75) Inventors: Frantisek Svec, Alameda, CA (US); Pavel A. Levkin, Eggenstein-Leopoldshafen (DE); Jean M.J. Frechet, Oakland, CA (US)

Correspondence Address: Weaver Austin Villeneuve & Sampson LLP, P.O. BOX 70250, OAKLAND, CA, 94612-0250, US

(73) Assignee: THE REGENTS OF THE UNIVERSITY OF CALIFORNIA, Oakland, CA (US)

(21) Appl. No.: 12/988,497

(22) PCT Filed: Apr. 21, 2009
(86) PCT No.: PCT/US2009/041277

§ 371 Date: Oct. 18, 2010

Related U.S. Application Data
(60) Provisional application No. 61/051,830, filed on May 9, 2008.

(51) Int. Cl. B32B 3/10; C08J 9/00; B29C 65/00

(52) U.S. Cl. 428/141; 521/50; 264/41

(57) ABSTRACT

A broadly applicable method requiring no more than a single step facilitates the preparation of large area super hydrophobic or super hydrophilic surfaces on a variety of substrates such as such as glass, metal, plastic, paper, wood, concrete and masonry. The technique involves the free radical polymerization of common acrylic or styrenic monomers in the presence of porogenic solvents in a mold or on a free surface. The material can be semi- or fully-transparent and either super hydrophobic or super hydrophilic depending on the choice of the monomers. Because porosity and dual scale roughness are intrinsic bulk properties of the monolithic materials and not only a surface characteristic, the polymers can be powdered to produce a super hydrophobic powder or otherwise fragmented and attached to the surface of any object to render it super hydrophobic or super hydrophilic. The surface properties of the porous material may also be altered locally by photografting with selected monomers.

### CROSS-REFERENCE TO RELATED APPLICATION

This application claims priority to U.S. Provisional Patent Application No. 61/051,830, entitled “SUPERHYDROPHOBIC AND SUPERHYDROPHILIC MATERIALS, SURFACES AND METHODS,” which was filed on May 9, 2008 and which is hereby incorporated by reference in its entirety.

### STATEMENT OF GOVERNMENTAL SUPPORT

The invention described and claimed herein was made at least in part utilizing funds supplied by the U.S. Department of Energy under Contract No. DE-AC02-05CH11231. The Government has certain rights in this invention.

### BACKGROUND OF THE INVENTION

The phenomenon of superhydrophobicity has evolved over millions of years in nature and manifests itself in examples such as lotus leaves or water strider legs. Superhydrophobic surfaces are defined as those that exhibit water contact angles exceeding 150° with a contact angle hysteresis of less than 10°. Superhydrophobicity results from a combination of intrinsic hydrophobic properties of the material that forms the surface as well as microscale and nanoscale roughness of that surface.

A variety of approaches to synthetic superhydrophobic surfaces have been recently developed. A description of current state of the art is provided by Li et al. “What we need for a superhydrophobic surface? A review on the recent progress in the preparation of superhydrophobic surfaces”, Chem. Soc. Rev. 2007, 36, 1350-1368. Many of the techniques described in the literature for the preparation of superhydrophobic surfaces involve long and multi-step procedures and sometimes harsh conditions, or complex and costly reagents and equipment. These drawbacks have significantly limited the practical applications of the superhydrophobic surfaces.

### SUMMARY OF THE INVENTION

The present invention pertains generally to polymer materials and coatings, in particular to superhydrophobic and superhydrophilic surfaces and methods for their preparation. According to various aspects of the invention, a broadly applicable method requiring no more than a single step is provided that facilitates the preparation of large area superhydrophobic or superhydrophilic surfaces on a variety of substrates such as glass, metal, plastic, paper wood, concrete and masonry. The technique involves the free radical polymerization of common acrylic or styrenic monomers in the presence of porogenic solvents in a mold or on a free surface. This approach affords a highly porous monolithic polymeric material that possesses desired dual micro- and nano-scale surface roughness. The material can be freestanding (e.g., an exposed monolith or powder), an exposed surface layer on virtually any substrate, semitransparent or fully transparent and either superhydrophobic or superhydrophilic depending on the choice of the monomers. Because porosity and dual scale roughness are intrinsic bulk properties of the monolithic materials and not only a surface characteristic, the polymers can be powdered to produce a superhydrophobic powder or otherwise fragmented and attached to the surface of any object to render it superhydrophobic or superhydrophilic.

In another aspect, the surface properties of the porous material may be altered locally by photografting with selected monomers. For example, photopatterning of a superhydrophobic monolithic polymer layer, such as poly(butyl methacrylate-co-ethylene dimethacrylate) (BuMA-EDMA) with a hydrophilic monomer, such as polar [2-(methacryloyloxy)ethyl]-trimethylammonium chloride (META), generates surface tension-confined superhydrophilic virtual microfluidic channels in the monolithic polymer layer.

These and other aspects and applications of the superhydrophobic and superhydrophilic materials of the present invention are described in more detail in the description that follows.

### BRIEF DESCRIPTION OF THE DRAWINGS

FIG. 1 depicts superhydrophobic and superhydrophilic porous polymers prepared in accordance with the present invention. Shown are water droplets on the smooth and porous polymeric layers and scanning electron microscope images of the porous polymeric layers: a,b BuMA-EDMA; c,d BuMA-EDMA₅₀; e,f styrene-divinylbenzene (ST-DVB); g,h methyl methacrylate (MMA)-EDMA; i,j 2-hydroxyethyl methacrylate(2-hydroxyethyl methacrylate)-EDMA.

FIG. 2 depicts water droplets resting on superhydrophobic surfaces prepared on different substrates in accordance with the present invention: a, Metal plate (stainless steel). b, Aluminum foil. c, Plastic tape. Water was colored with methylene blue dye to facilitate viewing.

FIG. 3 depicts superhydrophobic powder. a, SEM micrographs of the powder adhered to a sticky tape. Inset: water droplet on this surface. Scale bars on the left and on the right SEM images equal to 200 μm and 20 μm, respectively. b, Water droplets on a glove coated with the superhydrophobic powder. c, Picture of droplets of concentrated water solutions of sodium hydroxide (left) and hydrochloric acid (right) resting on a paper tissue coated with the superhydrophobic powder.

FIG. 4 depicts semi-transparent superhydrophobic film. a and b, SEM images of the cross-section (scale bar 20 μm) and the top view (scale bar 50 μm) of the 5 μm semi-transparent superhydrophobic layer. c, Photograph of a water droplet on a glass plate coated with the semi-transparent superhydrophobic film. d, UV-Vis transmittance spectrum of the film.

FIG. 5 depicts a water droplet on a porous HEMA-EDMA surface photografted with hydrophobic 2,2,3,3,3-pentafluoropropyl methacrylate. The values of θₛₜ, θ_{adv} and θ_{rec} on this surface are 170°, 171° and 168°, respectively.

FIG. 6 depicts surface tension confined microfluidic channels. a, A photograph of five microfluidic superhydrophilic channels prepared in the 50 μm thick superhydrophobic film (BuMA-EDMA). The channels are filled with water solutions of Rhodamine 6G and Brilliant Blue R dyes. b, An optical microscope image of the cross-section of a superhydrophilic 200 μm wide channel (colored with Rhodamine 6G) prepared in the 50 μm thick superhydrophobic film. c, SEM image of the cross-section of the 50 μm thick superhydrophobic film.

### DETAILED DESCRIPTION OF SPECIFIC EMBODIMENTS

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

### Introduction

A broadly applicable method requiring no more than a single step facilitates the preparation of large area superhydrophobic or superhydrophilic surfaces on a variety of substrates such as glass, metal, plastic, paper, wood, concrete and masonry. The technique involves the free radical polymerization of common acrylic or styrenic monomers in the presence of porogenic solvents in a mold or on a free surface. This approach affords a highly porous monolithic polymeric material that possesses desired dual micro- and nano-scale roughness—the resulting porous polymer has both microglobules and nano features on the microglobules, as described with reference to and shown in the figures. The material can be freestanding (e.g., an exposed monolith or powder), an exposed surface layer on virtually any substrate, semi-transparent or fully transparent and either superhydrophobic or superhydrophilic depending on the choice of the monomers. Because porosity and dual scale roughness are intrinsic bulk properties of the monolithic materials and not only a surface characteristic, the polymers can be powdered to produce a superhydrophobic powder or otherwise fragmented and attached to the surface of any object to render it superhydrophobic or superhydrophilic. The surface properties of the porous material may also be altered locally by photografting with selected monomers.

Depending on the value of the contact angle (CA), surface properties are determined as hydrophobic (CA greater than 90°) or hydrophilic (CA less than 90°). Maximum water CA on a smooth surface is about 120°. In practice, two types of CA values are used: static and dynamic CAs. Static CAs are obtained by sessile drop measurements, where a drop is deposited on the surface and the value is obtained by a goniometer. Dynamic contact angles are non-equilibrium CAs and are measured during the growth (advancing CA) and shrinkage (receding CA) of a water droplet. The difference between advancing CA and receding CA is defined as contact angle hysteresis (CAH). Surfaces with high water CA (greater than 150°) and low water CAH (less than about 10°) are called superhydrophobic. Water droplets do not stick to such surfaces and simply roll off. Surfaces with water CA close to or of 0° are called superhydrophilic. Water droplets are rapidly absorbed by such surfaces.

### Materials and Reagents

Materials in accordance with the present invention can be freestanding, comprising a porous polymer monolith or powder having intrinsic bulk superhydrophobicity or superhydrophilicity. The invention also includes composite articles, comprised of a substrate and an exposed monolithic or powder surface coating the substrate, the surface comprising a porous polymer having intrinsic bulk superhydrophobicity or superhydrophilicity. The materials can be prepared by free radical polymerization of common acrylic or styrenic monomers in the presence of porogenic solvents in a mold or on a free surface.

Superhydrophobic Monolith

A superhydrophobic porous polymer monolith in accordance with the present invention can be comprised of a crosslinked polyvinyl monomer, wherein the polyvinyl monomer is one or more monomers selected from the group consisting of alkylene diacrylates, alkylene dimethacrylates, pentaerythritol tetraacrylate, pentaerythritol tetramethacrylate, trimethylopropane acrylate, trimethylopropane methacrylate, divinylbenzene, and divinylnaphthalene. In one embodiment, the polyvinyl monomer is selected from group consisting of ethylene dimethacrylate and divinylbenzene.

The superhydrophobic porous polymer monolith may further comprise a monovinyl monomer, wherein the monovinyl monomer is selected from the group consisting of alkyl acrylates, alkyl methacrylates, aryl acrylates, aryl methacrylates, aryl alkyl acrylates, aryl alkyl methacrylates, fluorinated alkyl acrylates, fluorinated alkyl methacrylates, styrene, vinylnaphthalene, vinylanthracene, and derivatives thereof, wherein the alkyl group in each of the alkyl monomers has 1-18 carbon atoms. In one embodiment, the monovinyl monomer is selected from the group consisting of butyl methacrylate, benzyl methacrylate and styrene.

Superhydrophilic Monolith

A superhydrophilic porous polymer monolith in accordance with the present invention can be comprised of a crosslinked polyvinyl monomer, wherein the polyvinyl monomer is one or more monomers selected from the group consisting of alkylene diacrylates, alkylene dimethacrylates, alkylene diacrylamides, alkylene dimethacrylamides, hydroxyalkylene diacrylates, hydroxyalkylene dimethacrylates, wherein the alkylene group consists of 1-4 carbon atoms, oligoethylene glycol diacrylates, vinyl esters of polycarboxylic acids, pentaerythritol diacrylate, pentaerythritol triacrylate, pentaerythritol dimethacrylate, and pentaerythritol trimethacrylate. In one embodiment, the polyvinyl monomer is selected from the group consisting of ethylene dimethacrylate and methylene-bis-acrylamide.

The superhydrophilic porous polymer monolith may further comprise a monovinyl monomer, wherein the monovinyl monomer is selected from the group consisting of vinylacetate, vinylpyrrolidone, acrylic acid, methacrylic acid, methacrylamide, acrylamide, alkyl derivatives of methacrylamide, alkyl derivatives of acrylamide, wherein the alkylene group consists of 1-4 carbon atoms, hydroxyalkyl acrylates and acrylamides, hydroxyalkyl methacrylates and methacrylamides, oligoethylene glycol acrylates and oligoethylene glycol methacrylates, potassium 3-sulfopropyl acrylate, potassium 3-sulfopropyl methacrylate, 2-acryloamido-2-methyl-1-propanesulfonic acid, 2-acrylamidoglycolic acid, [2-(methacryloyloxy)ethyl]trimethylammonium chloride, and N-[3-(dimethylamino)propyl]methacrylamide. In one embodiment, the monovinyl monomer is selected from the group consisting of 2-hydroxyethyl methacrylate, decaethylene glycol methacrylate, N-isopropylacrylamide, and acrylamide.

Porogens and Porous Properties

The porous properties of a superhydrophobic or superhydrophilic porous polymer monolith can be controlled by the total polymerization time, temperature and/or irradiation power, percentage of monomers, concentration of initiator, and composition and percentage of the porogen in the porogenic solvent. The porous structure of the monolith results from the phase separation of solid polymer microglobules during the polymerization reaction that is modulated by the crosslinker and thermodynamic quality of the porogenic solvent, which in turn depends on its composition and percentage in the polymerization mixture. A broad range of porous properties can be readily achieved by adjustments in the composition of porogenic solvent.

The porogen used to prepare a monolithic porous polymer matrix in accordance with the present invention may be selected from a variety of different types of compounds. For example, suitable liquid porogens include aliphatic hydrocarbons, aromatic hydrocarbons, esters, amides, alcohols, ketones, ethers, solutions of soluble polymers, and mixtures thereof. For preparation of superhydrophilic materials, water may also be used. The porogen is generally present in the polymerization mixture in an amount of from about 40 to 90 vol %, more preferably from about 50 to 80 vol %. In a preferred embodiment, the porogen is 1-decanol and cyclohexanol.

### Polymerization

Polymerization can be carried out using various methods of free radical initiation mechanisms including but not limited to thermal initiation, photoinitiation, and redox initiation. Further details of such polymerization can be fund in Wang Q. C., Svec F., Fréchet J. M. J., Anal Chem. 65, 2243-2248, 1993; Yu C., Svec F., Fréchet J. M. J., Electrophoresis 21, 120-127, 2000; and Holdsvendova, P.; Coufal, P.; Suchankova, J.; Tesarova, E.; Bosakova, Z. J. Sep. Sci. 2003, 26, 1623-28. About 0.1-5 wt % (with respect to the monomers) of free radical initiator or photoinitiator can be used to create a superhydrophobic or superhydrophilic polymer monolith.

When polymerization is carried out by thermal initiation, the thermal initiator is generally a peroxide, a hydroperoxide, or an azo-compound selected from the group consisting of benzoyl peroxide, potassium peroxodisulfate, ammonium peroxodisulfate, t-butyl hydroperoxide, 2,2′-azobisiobutyronitrile (AIBN), and azobisiocyanobutyric acid, and the thermally induced polymerization is performed by heating the polymerization mixture to temperatures between 30° C. and 120° C.

Polymerization leading to a monolith can also be achieved using photoinitators including, but not limited to, benzophenone, 2,2-dimethoxy-2-phenylaceto-phenone, dimethoxyacetophenone, xanthone, thioxanthone, camphorquinone their derivatives, and mixtures thereof.

In another embodiment, polymerization is initiated by a redox initiator, that may be selected from the group consisting of mixtures of benzoyl peroxide-dimethylaniline, and ammonium peroxodisulfate-N,N,N′,N′-tetramethylene-1,2-ethylenediamine.

As described herein, a bulk piece of porous superhydrophobic or superhydrophilic polymer can be prepared in a container, such as a vial, by free radical polymerization induced by any of the techniques noted above. The solid polymer so formed can be used in its monolithic form for a variety of applications. Alternatively, the bulk monolith can be subsequently ground to a powder using a mortar and pestle, milling instrument, or any other grinding device and then the powder can be sieved.

Alternatively, a planar mold may be used. A polymerization mixture can be injected into a thin gap between two plates of glass (or other suitable material such as metal or plastic). The thickness of the gap determines the thickness of the polymeric layer and can be defined by the thickness of strips placed between the two glass plates near the edges. Polymerization can be then initiated thermally or by UV irradiation of the mold. In other similar embodiments, a gap may be formed between non planar elements to form an appropriate mold.

The porous polymers may also be prepared in accordance with the invention by a polymerization reaction carried out on a free surface. According to this technique, the deaerated polymerization mixture is evenly distributed on a solid surface and polymerized under inert atmosphere using irradiation with UV light (e.g., 254 nm, 4 mW/cm²) for 15 min followed by a washing step (e.g., using methanol as a solvent) and drying.

### Superhydrophobic or Superhydrophilic Surfaces

Superhydrophobic or superhydrophilic surface layers may be applied to virtually any substrate in accordance with this invention to form composites with superhydrophobic or superhydrophilic surfaces. One technique to accomplish this involves applying a powder of the material to the substrate. The powder may be applied using anything that would adhere the polymer powder to the substrate. Examples of such adhesion media include, but are not limited to glues, hardening adhesives, and tapes.

Another technique involves shearing a layer by attaching a sticky tape to a superhydrophobic or superhydrophilic material layer. Peeling the tape off the layer leaves a thin sheared superhydrophobic or superhydrophilic layer on the tape. Since only a very thin layer is transferred to the plastic tape, the procedure can be repeated several times with new sticky tapes and the same superhydrophobic or superhydrophilic polymer. A double sided sticky tape can also be used. In this case, after rendering one of the sides of the tape superhydrophobic or superhydrophilic, the tape can be easily stuck to virtually any surface of any substrate using the other side of the sticky tape to produce a superhydrophobic or superhydrophilic surface on the substrate.

Also, as noted above, a superhydrophobic or superhydrophilic surface layer can be formed on a substrate such a glass, metal, plastic or other material plate by a free surface polymerization on the plate substrate, or by polymerization in a gap between the substrate and another element that is subsequently removed. These techniques are described in further detail below.

### Grafting

In addition to direct polymerization of crosslinkers and monomers described above, grafting is another way of tailoring surface chemistry. Attachment of chains of polymer to the sites at the pore surface of the porous monolith dramatically changes character of surface functionalities. Examples of grafting and functionalization of porous polymers and monoliths using free radical initiation are known (e.g., Tripp J. A., Svec F., Fréchet J. M. J., J. Combi. Chem. 2001, 3, 216-223; Viklund, C., Irgum K., Macromolecules 2000, 33, 2539-2544; U.S. Pat. No. 5,929,214).

Alternatively, photoinitiated grafting not only enables changes in character of surface functionalities but also affords the functionalization of only specific parts of the porous polymer matrix when carried out via UV irradiation through a mask (Rohr T., Hilder E. F., Donovan J. J., Svec F., Fréchet J. M. J., Macromolecules 36, 1677-1684, 2003; U.S. patent application Ser. No. 10/665,900, filed Sep. 19, 2003).

The use of these grafting and functionalization techniques in the context of the present invention leads to novel structures, such as surface tension confined microchannels.

### Applications

The superhydrophobic or superhydrophilic materials and processes of the present invention have a myriad of potential applications including surface coatings for preventing corrosion, chemical reaction, and contamination of a substrate surface with living organisms such as bacteria and viruses; as self-cleaning surfaces for roofs, windows, auto glass, solar collectors, antennas, and head lamps; and as sensors in automobiles and aircrafts.

In a research context, superhydrophobic surfaces on MALDI-MS plates enable efficient focused concentration of samples prior to the analysis. Superhydrophobic surfaces can also be useful for efficient crystallization of proteins resulting from the fact that water droplets placed on the surface are suspended on the surface. Thus, the water-solid surface interface is minimized, which is important for undisturbed efficient crystal growth.

Another application is the separation of aqueous solutions from apolar solvents. This application can be important, for example, for water treatment or purification, and cleaning up of oil spills. The separation is based on the low surface energy of apolar liquids which results in that most superhydrophobic surfaces becoming oleophilic and easily wetted with these liquids yet not with water. A superhydrophobic membrane can selectively transmit low surface tension organic solvents immiscible with water while at the same time remaining waterproof.

### Examples

The following examples provide details illustrating process specifics, advantageous properties and applications in accordance with the present invention. These examples are provided to exemplify and more clearly illustrate aspects of the present invention and are in no way intended to be limiting.

Instrumentation

An OAI Model 30 deep UV collimated light source (San Jose, Calif., USA) fitted with a 500-W HgXe lamp was used for UV exposures. The irradiation power was calibrated to 4.4 mW/cm² using an OAI Model 306 UV power meter with a 260-nm probe head. Scanning electron micrographs were obtained using the Zeiss Gemini Ultra-55 Analytical Scanning Electron Microscope. The samples were gold-sputtered using the BAL-TEC SCD 050 sputter coater. Optical microscopy images were acquired using the Leica DM4000 Optical Microscope. UV-3000 Shimadzu Spectrophotometer was used for acquiring UV-Vis spectra. “Easy Drop” Krüss GmbH (Germany) instrument was used to take pictures of water micro drops. ImageJ software with a DropSnake plugin was used to measure the contact angles. An average standard deviation of the values of water contact angles was 3°. The photomask was purchased from HTA Photomask (San Jose, Calif.). 12 cm×3.3 cm, 1.1 mm thick, Borofloat glass plates were purchased from S. I. Howard Glass Co. Inc. Worcester, Mass.

All chemicals were purchased from Aldrich. Monomers were purified by passing through a short column packed with inhibitor remover packing material (Aldrich). All the polymerization and photografting mixtures were deaerated before use by purging with nitrogen for 10 min.

Glass Surface Modification

To increase the density of the hydroxyl groups on the surface, the glass plates were washed with water, dried and then immersed in a 0.2 mol/L NaOH water solution for 30 min. Then the plates were rinsed with water and immersed into a 0.2 mol/L HCl solution for 30 min followed by washing with water and drying with a nitrogen gun. The activated glass surface was silylated with 3-(trimethoxysilyl)propyl methacrylate, which was necessary to achieve the covalent attachment of the polymeric layers to glass surface: several drops of a solution containing 20% vol. of 3-(trimethoxysilyl)propyl methacrylate in ethanol adjusted to pH=5 with acetic acid were dropped on the surface of one glass plate. This plate was covered with another glass plate. The solution was reapplied after 30 min. After another 30 min, the plates were washed with acetone and dried with nitrogen.

Polymerization Mixtures

The following polymerization mixtures were used to prepare polymers in the Examples:

Porous poly(butyl methacrylate-co-ethylene dimethacrylate) (BuMA-EDMA) (photoinitiation). Butyl methacrylate (24% wt.), ethylene dimethacrylate (16% wt.), 1-decanol (40% wt.), cyclohexanol (20% wt.) and 2,2-dimethoxy-2-phenylacetophenone (1% wt. with respect to monomers).

Porous poly(butyl methacrylate-co-ethylene dimethacrylate) (BuMA-EDMA) (thermal initiation). Butyl methacrylate (24% wt.), ethylene dimethacrylate (16% wt.), 1-decanol (40% wt.), cyclohexanol (20% wt.) and 2,2′-azobisisobutyronitrile (AIBN) (1% wt. with respect to monomers).

Porous poly(butyl methacrylate-co-ethylene dimethacrylate) (BuMA-EDMA) (photoinitiation)—50% wt. of the monomers in the polymerization mixture, hence different morphology. Butyl methacrylate (30% wt.), ethylene dimethacrylate (20% wt.), 1-decanol (33.3% wt.), cyclohexanol (16.7% wt.) and 2,2-dimethoxy-2-phenylacetophenone (1% wt. with respect to monomers).

Nonporous poly(butyl methacrylate-co-ethylene dimethacrylate) (BuMA-EDMA) (photoinitiation). Butyl methacrylate (60% wt.), ethylene dimethacrylate (40% wt.) and 2,2-dimethoxy-2-phenylacetophenone (1% wt. with respect to monomers).

Porous poly(methyl methacrylate-co-ethylene dimethacrylate) (MMA-EDMA) (photoinitiation). Methyl methacrylate (24% wt.), ethylene dimethacrylate (16% wt.), 1-decanol (40% wt.), cyclohexanol (20% wt.) and 2,2-dimethoxy-2-phenylacetophenone (1% wt. with respect to monomers).

Nonporous poly(methyl methacrylate-co-ethylene dimethacrylate) (MMA-EDMA) (photoinitiation). Methyl methacrylate (60% wt.), ethylene dimethacrylate (40% wt.) and 2,2-dimethoxy-2-phenylacetophenone (1% wt. with respect to monomers).

Porous poly(2-hydroxyethyl methacrylate-co-ethylene dimethacrylate) (HEMA-EDMA) (photoinitiation). 2-Hydroxyethyl methacrylate (24% wt.), ethylene dimethacrylate (16% wt.), 1-decanol (40% wt.), cyclohexanol (20% wt.) and 2,2-dimethoxy-2-phenylacetophenone (1% wt. with respect to monomers).

Nonporous poly(2-hydroxyethyl methacrylate-co-ethylene dimethacrylate) (HEMA-EDMA) (photoinitiation). 2-Hydroxyethyl methacrylate (60% wt.), ethylene dimethacrylate (40% wt.) and 2,2-dimethoxy-2-phenylacetophenone (1% wt. with respect to monomers).

Porous poly(styrene-co-divinylbenzene) (ST-DVB) (thermal initiation). Styrene (24% wt.), divinylbenzene (80% grade, 16% wt.), 1-decanol (50% wt.), tetrahydrofurane (10% wt.) and 2,2′-azobisisobutyronitrile (1% wt. with respect to monomers).

Nonporous poly(styrene-co-1,4-divinylbenzene) (ST-DVB) (thermal initiation). Styrene (60% wt.), divinylbenzene (80% grade, 40% wt.) and 2,2′-azobisisobutyronitrile (1% wt. with respect to monomers).

Porous poly(2,2,3,3,3-pentafluoropropyl methacrylate-co-ethylene dimethacrylate) (PFPMA-EDMA) (photoinitiation). 2,2,3,3,3-pentafluoropropyl methacrylate (24% wt.), ethylene dimethacrylate (16% wt.), 1-decanol (40% wt.), cyclohexanol (20% wt.) and 2,2-dimethoxy-2-phenylacetophenone (1% wt. with respect to monomers).

Polymerization Procedures

Polymerization mixtures were injected into a thin gap between two glass plates. The thickness of the gap determined the thickness of the polymeric layer and was defined by the thickness of two Teflon strips (American Durafilm Co.) placed between the two glass plates near the edges. The thickness of the commercially available strips varies from 12.5 μm to more than 500 μm. In the case of the UV-initiated polymerization, the reaction was initiated by UV light with a wavelength of 254 nm and an intensity of 4.4 mW/cm² for 15 min. In the case of the thermal initiator, the polymerization was initiated by heating the mold at 70° C. for 24 h. The polymerization led to a thin porous polymeric layer that stuck to one of the glass plates that was modified with 3-(trimethoxysilyl)propyl methacrylate. This layer was washed with methanol for 2 min, dried and used for the further measurements.

The bulk porous poly(butyl methacrylate-co-ethylene dimethacrylate) was prepared by the thermally initiated polymerization of 10 mL of the polymerization mixture in a glass vial. The solid polymer was then grinded using a mortar and pestle. The produced powder was sieved through a 106 μm mesh size metal sieve (USA standard testing sieve, Gilson, Worthington, Ohio, USA).

### Example 1

### Method of Making Superhydrophobic BuMA-EDMA Materials and Surfaces and their Properties

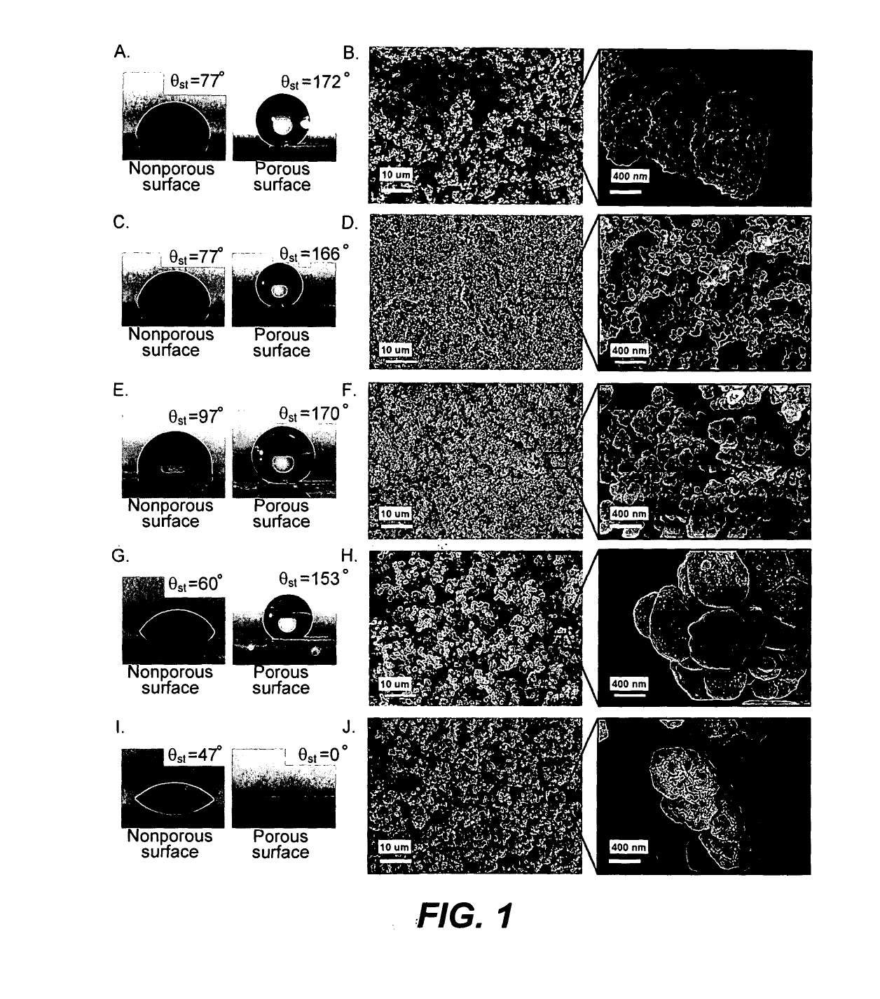

Photoinitiated polymerization of a mixture of butyl methacrylate (60% wt.) and ethylene dimethacrylate (40% wt.) in the presence of 2,2′-dimethoxy-2-phenylacetophenone as the UV initiator (1% wt.) between two glass plates leads to a transparent non-porous poly(butyl methacrylate-co-ethylene dimethacrylate) (BuMA-EDMA) layer with a smooth surface. The static water contact angle (θₛₜ) on this surface is 77° (FIG. 1a). However, when 20 parts of cyclohexanol and 40 parts of 1-decanol are added to 40 parts of the mixture of monomers and polymerized, the value of θₛₜ on the surface of the produced polymeric layer increases up to 172° (FIG. 1a). The advancing and receding water contact angles (θ_{adv} and θ_{rec}, respectively) increase from 89° and 66° to 174° and 171°, respectively. The polymer becomes superhydrophobic and water droplets bounce on its surface and easily roll off the surface even at a tiny incline.

While the invention is not limited to any particular theory of operation, it is understood that the superhydrophobicity is the result of high roughness of a hydrophobic material. In the presence of cyclohexanol and 1-decanol (porogens) which are not incorporated into the polymer, a phase separation occurs when the growing polymer chains achieve a critical size. As the result, a highly porous interconnected globular structure is formed (FIG. 1b). Scanning electron microscopy (SEM) of the polymer also reveals the dual scale roughness on both micro- and nano-scale (FIG. 1b).

To achieve superhydrophobicity on a rough surface demonstrated by very high contact angle, the intrinsic θₛₜ of the non-porous polymer, i.e., the static water contact angle on a smooth surface made of the same material is assumed to be above 90°—that is, the non-porous polymer has intrinsic hydrophobicity. If the intrinsic θₛₜ of the material is below 90°—intrinsic hydrophilicity—the rough nature of the same surface usually leads to a decrease in the water contact angle. Interestingly, the value of the intrinsic θₛₜ on the surface of BuMA-EDMA is 77°, i.e., the polymer itself is slightly hydrophilic. The superhydrophobicity of a material with inherently hydrophilic properties can be explained by the presence of concave topographical features on the surface. The interconnected microglobules observed by SEM on the porous surface of the BuMA-EDMA represent an example of the concave topographical features which explain the unusual superhydrophobic behavior of this material.

As a basic procedure for the preparation of the polymeric thin films on a glass substrate, the polymerization mixture containing monomers, porogens (only for making porous polymers) and a UV (2,2′-dimethoxy-2-phenylacetophenone) or thermal (2,2′-azobisisobutyronitrile) initiator was injected into a thin gap between two glass plates. The thickness of the gap determined the thickness of the polymeric layer and was defined by the thickness of two Teflon strips placed between the glass plates near the edges. The thickness of commercially available strips varied from 12.5 μm to more than 500 μm. The free-radical photopolymerization was initiated by irradiation of the filled mold with UV light with a wavelength of 254 nm and an intensity 4.4 mW/cm² for 15 min. The free radical thermally-initiated polymerization was accomplished by heating the polymerization mixture at 70° C. for 24 h. The polymerization led to a thin polymeric film that was covalently attached to one of the glass plates modified with 3-(trimethoxysilyl)propyl methacrylate. This layer was washed with methanol for 2 min, dried in air and used for the study.

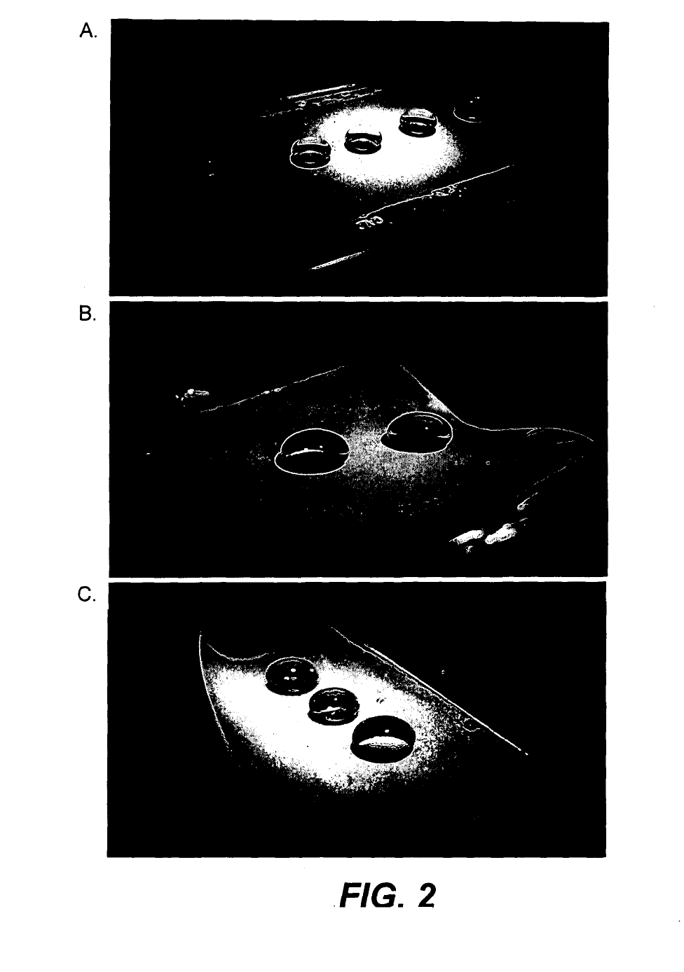

In addition to the glass plates, a BuMA-EDMA superhydrophobic surface was prepared on a metal plate (FIG. 2a) and flexible aluminum foil (FIG. 2b) by photopolymerization of the reaction mixture directly on these materials. To prepare the superhydrophobic BuMA-EDMA surface on a metal plate, the polymerization mixture was injected in between the metal plate and a glass plate followed by UV-initiated polymerization (15 min at intensity 4.4 mW/cm²). The same procedure was used to prepare the superhydrophobic layer on aluminum foil. It is important to note that the superhydrophobic layer adhered to the metal surface without the need for surface modification. To prepare the superhydrophobic BuMA-EDMA or ST-DVB layer on a plastic film, a sticky tape was attached to the 50 μm-thick superhydrophobic BuMA-EDMA layer. Peeling the tape off the plate left a thin superhydrophobic BuMA-EDMA layer on the plastic tape. The static, advancing and receding water contact angles obtained on the BuMA-EDMA prepared on metal plate, aluminum foil, paper and plastic film were virtually the same as on the BuMA-EDMA layers prepared on glass plates.

The superhydrophobic layer could also be easily transferred to a plastic tape by attaching the sticky tape to a 50 μm-thick superhydrophobic BuMA-EDMA layer prepared on a glass plate. Peeling the tape off the plate left a thin superhydrophobic layer strongly adhered to the tape (FIG. 2c).

These are the easiest known methods for the preparation of superhydrophobic surfaces on different substrates.

Because of the crosslinked nature, the BuMA-EDMA superhydrophobic polymer is not soluble in any organic solvent. It should be noted that the superhydrophobicity of the monolithic porous polymer layers is more stable compared to the superhydrophobicity of two-dimensional surfaces made, e.g. by roughening a smooth hydrophobic surface. This is because the superhydrophobic surfaces described here have certain thickness and the superhydrophobicity is the property of the bulk material.

The superhydrophobicity prevents viscous water solutions (e.g., sugar syrup or honey) from sticking to such surfaces and, therefore, such solutions simply roll off when the surface was inclined.

When a glass plate coated with the superhydrophobic layer of BuMA-EDMA is immersed in water and viewed at a glancing angle it reflects light. While no aspect of the invention is limited by a particular theory, the reflectance of light as well as the high values of θ_{adv} and θ_{rec} suggest that the superhydrophobicity is based on the Cassie-Baxter model. This model explains the superhydrophobicity as the result of air trapped in the micro grooves of the rough surface. Therefore, water droplets rest on a composite surface—a combination of air and the tops of the micro protrusions.

### Example 2

### Composition, Preparation and Properties of Other Superhydrophobic and Superhydrophilic Materials and Surfaces

To demonstrate the generality of the approach for the preparation of superhydrophobic materials, poly(styrene-co-divinylbenzene) as another common polymer with slightly more hydrophobic nature (intrinsic θₛₜ=97°) was studied. Because of the UV absorptive properties of the styrenic monomers, photopolymerization with 2,2′-dimethoxy-2-phenylacetophenone could not be used in this case. However, thermally initiated polymerization of a mixture of styrene (24% wt.), divinylbenzene (80% grade, 16% wt.), 1-decanol (50% wt.), tetrahydrofuran (10% wt.) and 2,2′-azobisisobutyronitrile (1% wt. with respect to monomers) afforded the porous poly(styrene-co-divinylbenzene) (ST-DVB). The θₛₜ on the produced porous polymer increased to 170° (FIG. 1e). The SEM micrographs revealed a network of interconnected microglobules with significantly smaller size in comparison to that of the BuMA-EDMA porous polymer (FIG. 1f). The dual scale roughness observed in the case of BuMA-EDMA was also clearly visible in the case of ST-DVB (FIG. 1f). The values of θ_{adv} and θ_{rec} increased from 102° and 83° obtained on the nonporous polymer to 171° and 162° obtained on the porous polymer, respectively, indicating pronounced superhydrophobicity in the latter case. Another method affording a superhydrophobic layer from styrenic monomers is photopolymerization initiated by camphorquinone. In addition, γ-radiation initiated polymerization can be also used.

Similarly, porous poly(methyl methacrylate-co-ethylene dimethacrylate) (MMA-EDMA) and poly(2,2,3,3,3-pentafluoropropyl methacrylate-co-ethylene dimethacrylate) (PFPMA-EDMA) porous thin layers could be easily prepared (see experimental data). Despite significantly more hydrophilic nature of MMA-EDMA (intrinsic θₛₜ=60°), generating porosity on the surface also increased the hydrophobicity of the material significantly (θₛₜ=153°) (FIG. 1g). The morphology of the polymer was similar to that of the BuMA-EDMA porous polymer. SEM micrographs are shown in FIG. 1h. Incorporating highly hydrophobic monomer, 2,2,3,3,3-pentafluoropropyl methacrylate (PFPMA), by copolymerization of PFPMA with EDMA using the same composition of the polymerization mixture as in the case of BuMA-EDMA, resulted in the porous PFPMA-EDMA with pronounced superhydrophobicity characterized by values of both θₛₜ, θ_{adv} and θ_{rec} close to 170°.

The morphology of porous polymers depends mainly on the composition of the polymerization mixture and the temperature at which polymerization is carried out. Since morphology is an important factor, e.g., for achieving superhydrophobicity or superhydrophilicity, mechanical stability, light transparency etc., we examined properties of the porous BuMA-EDMA₅₀ prepared using slightly different composition of the polymerization mixture. Instead of 40% wt. of the mixture of butyl methacrylate and ethylene dimethacrylate monomers as described above, in this case we used 50% wt. of this mixture in the same porogens. As viewed by SEM (FIG. 1d), the BuMA-EDMA₅₀ polymer possessed highly porous structure of interconnected microglobules. The globules were significantly smaller in size and stronger interconnected as compared to those of the BuMA-EDMA. As the result, the mechanical stability of the polymer was significantly improved. In addition, the stability of the superhydrophobic state was also increased probably because of the smaller pore size in BuMA-EDMA₅₀ polymer. Similarly, the morphology can be tuned by varying the ratio and nature of the monomers and porogens, by varying temperature of the polymerization etc. As the result, mechanical properties, hydrophobicity, transparency and other physical properties can be controlled and tailored to particular applications.

Properties of the various polymers prepared and tested are noted in Table 1.

TABLE 1
Water contact angles on porous and nonporous polymeric surfaces.

| | θₛₜ | θ_{adv} | θ_{rec} |
|---|---|---|---|
| BuMA-EDMA (nonporous) | 77 | 89 | 66 |
| BuMA-EDMA 40 (porous) (superhydrophobic) | 172 | 174 | 171 |
| BuMA-EDMA 40 (porous/powder) | 172 | 178 | 170 |
| (superhydrophobic) | | | |
| BuMA-EDMA 40 (porous) photografted with | 0 | 0 | 0 |
| META (superhydrophilic) | | | |
| BuMA-EDMA₅₀ (porous) (superhydrophobic) | 166 | 175 | 142 |
| MMA-EDMA (nonporous) | 60 | 77 | 44 |
| MMA-EDMA (porous) | 153 | 168 | 119 |
| ST-DVB (nonporous) | 97 | 102 | 83 |
| ST-DVB (porous) (superhydrophobic) | 170 | 171 | 162 |
| HEMA-EDMA (nonporous) | 47 | 57 | 22 |
| HEMA-EDMA (porous) (superhydrophilic) | 0 | 0 | 0 |
| HEMA-EDMA (porous) photografted with | 170 | 171 | 168 |
| PFPMA (superhydrophobic) | | | |

### Example 3

### Method of Making Superhydrophilic HEMA-EDMA and its Properties

Generating porosity on the surface of a significantly more hydrophilic poly(2-hydroxyethyl methacrylate-co-ethylene dimethacrylate) (HEMA-EDMA) polymer (intrinsic θₛₜ=47°) yielded a superhydrophilic material (both θₛₜ, θ_{adv} and θ_{rec}=0) (FIG. 1i,j). This is due to the fact that roughness increases both hydrophobicity and hydrophilicity of the material. Superhydrophilic materials have aroused great interest for potential practical applications such as self-cleaning windows and microfluidics. The porous HEMA-EDMA was prepared by free radical photopolymerization of a mixture of 2-hydroxyethyl methacrylate (24% wt.), ethylene dimethacrylate (16% wt.), 1-decanol (40% wt.), cyclohexanol (20% wt.) and 2,2-dimethoxy-2-phenylacetophenone (1% wt. with respect to monomers). The nonporous polymer used for measuring intrinsic water contact angles was obtained by polymerization of the same mixture of monomers 2-hydroxyethyl methacrylate (60% wt.), ethylene dimethacrylate (40% wt.) and 2,2-dimethoxy-2-phenylacetophenone (1% wt. with respect to monomers) without addition of porogens. The SEM study of the porous surface of HEMA-EDMA revealed a microstructure similar to that of the BuMA-EDMA porous polymer (FIG. 1j).

### Example 4

### Method of Making a Superhydrophobic Powder and Surface Coated Substrates

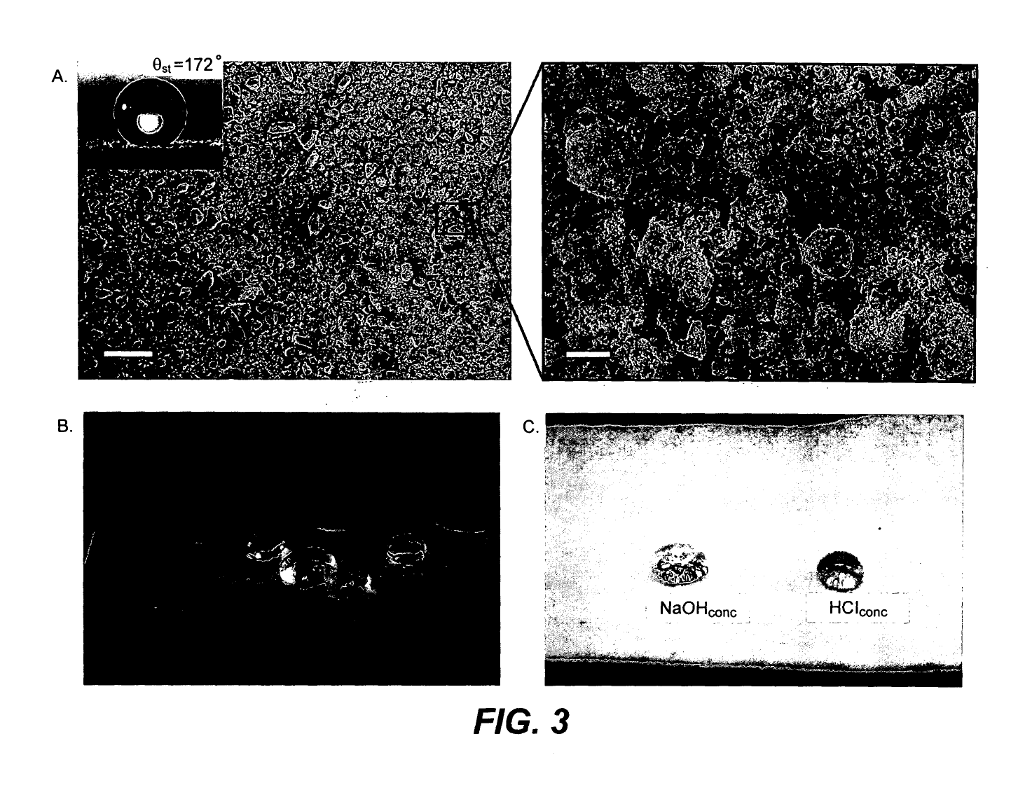

An intrinsic difference of the superhydrophobic polymeric surfaces described herein over the superhydrophobic surfaces fabricated by roughening the surface by, e.g., lithography or templating, is that the porosity is a bulk property of the whole material and not just its surface. As the result, the superhydrophobic property is maintained even after grinding the bulk polymer into a powder. To demonstrate this, a piece of porous BuMA-EDMA polymer was prepared in a 10 mL vial by thermally (70° C.) initiated free radical polymerization using AIBN as the initiator. The produced polymer was ground into powder using a mortar and pestle and sieved through a 106 μm mesh size sieve. Other size sieves may be used. The obtained powder was superhydrophobic and could be glued to virtually any substrate using an appropriate adhesive rendering the substrate superhydrophobic. Virtually anything that can adhere the powder to a substrate can be used. Examples of adhesives used in this study were UHU Stic™ glue stick to glue the superhydrophobic powder to a paper and cyanoacrylate-based glue (e.g., Super Glue™) for gluing the superhydrophobic powder to plastic or metal. Sticky tapes can also be used. The values of θₛₜ, θ_{adv} and θ_{rec} on a sticky tape coated with the superhydrophobic powder were as high as 172, 178 and 170°, respectively (inset on FIG. 3a).

Objects of different shapes can be coated with the superhydrophobic powder. For example, FIG. 3b shows behavior of water on a latex glove coated with the superhydrophobic powder. The water-repellent property of a paper tissue coated with the superhydrophobic powder was also observed. FIG. 3c shows two droplets on a paper tissue coated with the superhydrophobic powder: left droplet is concentrated solution of sodium hydroxide and the right one is concentrated hydrochloric acid. The observed anticorrosion property is caused by the superhydrophobicity and is the result of the extremely small fraction of the solid being in contact with the corrosive liquids. SEM micrographs of the superhydrophobic BuMA-EDMA powder glued to a sticky tape revealed a carpet of highly porous particles (FIG. 3a) responsible for the superhydrophobicity.

### Example 5

### Membranes Made of Superhydrophobic Materials

The separation of water solutions from organic solvents was demonstrated. The separation is based on the low surface energy of organic solvents. Since most superhydrophobic surfaces are oleophilic, they are easily wetted with these liquids yet not with water. A piece of a metal mesh was coated with superhydrophobic BuMA-EDMA powder using a common cyanoacrylate-based adhesive. The produced membrane could then selectively transmit organic solvents (e.g. hexane) immiscible with water, at the same time remaining waterproof. Other suitable substrates include fritted glass, porous polymer, membranes, filter paper, etc.

### Example 6

### Transparency and Thin Layer Formation of Superhydrophilic Surfaces

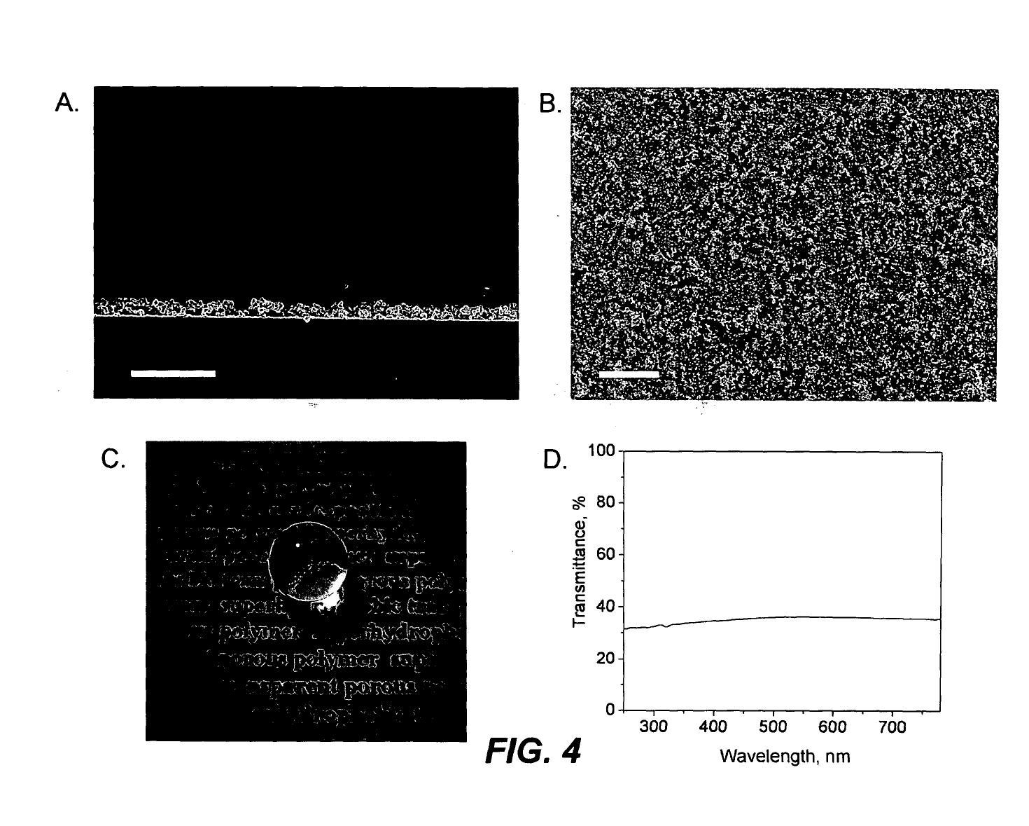

One of the most practical application of superhydrophobic surfaces is their use on glasses, e.g. for car windshields or for outdoor sensor devices. Just a few reports of optically transparent superhydrophobic surfaces are known. This rarity of reports is mainly due to the fact that superhydrophobicity requires roughness of the surface which in turn leads to light scattering. However, reducing the thickness of the coating can also decrease the light scattering and, provided the material is not light absorbing, a transparent superhydrophobic surface can be obtained. The thickness of a BuMA-EDMA porous layer was decreased to approximately 5 μm (FIG. 4a,b). The 5 μm-thick BuMA-EDMA porous layer was prepared in the same way as the thick (50 μm) layers, i.e., the polymerization mixture was injected into a thin gap between two surface modified glass plates. The 50 μm thickness of the gap was determined by the thickness of two Teflon strips (American Durafilm Co.) placed between the two glass plates near the edges. The photopolymerization the mold was initiated by UV light with an intensity of 4.4 mW/cm² for 15 min. The produced 50 μm-thick porous polymeric layer stuck to the top glass plate which was irradiated with UV, while the bottom glass plate was always covered with the thin (5-8 μm thick) semi-transparent porous polymeric layer. The transparency of such layer was significantly improved. Unlike the 50 μm-thick porous layer, which transmitted light but diffused it, the 5 μm-thick layer was semi-transparent (about 35% light transmittance) to light from 200 to 800 nm (FIG. 4c,d). Another way to improve transparency is to reduce the feature size of the microglobules forming porous monolithic layer. This can be easily achieved by changing the composition of the polymerization mixture. For example, increasing the amount of cyclohexanol in the porogen mixture leads to a significant improvement in transparency of the BuMA-EDMA monolith.

### Example 7

### Super/Hydrophilic-Hydrophobic Photografting and Applications

It has been shown that photografting can be used to control the surface chemistry of three-dimensional porous polymers. Photografting is performed by UV irradiation of a porous polymer surface wetted with the mixture containing a methacrylate monomer and benzophenone as an initiator which leads to the growth of polymeric chains from the polymer surface. This method was tested in the context of the present invention for controlling the wetting properties of the superhydrophobic porous polymers. It was observed that photografting of a superhydrophobic BuMA-EDMA surface with hydrophilic [2-(methacryloyloxy)ethyl]-trimethylammonium chloride (META) led to the superhydrophilicity of the surface. Values of both θₛₜ, θ_{adv} and θ_{rec} on the produced surface decreased to 0° and the surface acquired “sponge-like” property.

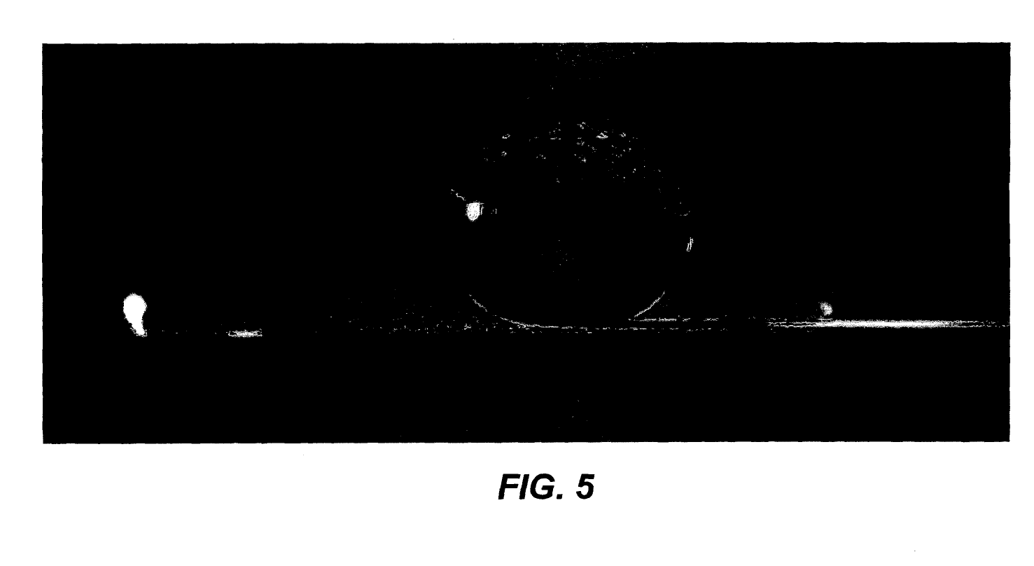

It is also possible to switch the superhydrophilic and “sponge-like” non-modified HEMA-EDMA porous polymer surface into the superhydrophobic and water repellent surface by photografting it with a hydrophobic 2,2,3,3,3-pentafluoropropyl methacrylate (PFPMA) (FIG. 5). The values of θₛₜ, θ_{adv} and θ_{rec} on the PFPMA-modified HEMA-EDMA porous surface increased from 0° to 170°, 171° and 168°, respectively.

Photografting of the superhydrophilic HEMA-EDMA 50 μm-thick porous layer with hydrophobic 2,2,3,3,3-pentafluoropropyl methacrylate (PFPMA) was performed as follows. The mixture for photografting contained 2,2,3,3,3-pentafluoropropyl methacrylate (PFPMA) (15% wt.) and benzophenone (0.25% wt.) dissolved in a mixture of water (25% vol.) and tert-butanol (75% vol.). The HEMA-EDMA porous layer was wetted with the photografting mixture. The plate was covered with 1.1 mm thick Borofloat glass plate and exposed to UV (λ=254 nm; 4.4 mW/cm²) for 15 min followed by washing the porous polymeric layer with methanol and drying it under nitrogen. The procedure was repeated twice.

Photografting of the superhydrophobic BuMA-EDMA 50 μm-thick layer with hydrophilic [2-(methacryloyloxy)ethyl]-trimethylammonium chloride (META) through a photomask was performed as follows. The mixture for photografting composed of [2-(methacryloyloxy)ethyl]-trimethylammonium chloride (META) (15% wt.) and benzophenone (0.25% wt.) dissolved in a 1:3 v/v mixture of water and tert-butanol. A glass plate with the porous polymeric layer was wetted with the photografting mixture. The plate was covered with a quartz photomask (HTA Photomask, San Jose, Calif.) and exposed to UV (4.4 mW/cm²) for 5 min followed by washing the porous polymeric layer with methanol and drying.

More details of appropriate photografting procedures can be found in Ranby, B., Yang, W. T., & Tretinnikov, O. Surface photografting of polymer fibers, films and sheets. Nucl. Instrum. Methods Phys. Res., Sect. B 151, 301-305 (1999); and Rohr, T., Hilder, E. F., Donovan, J. J., Svec, F., & Fréchet, J. M. J. Photografting and the Control of Surface Chemistry in Three-Dimensional Porous Polymer Monoliths. Macromolecules 36, 1677-1684 (2003); incorporated by reference herein for this purpose.

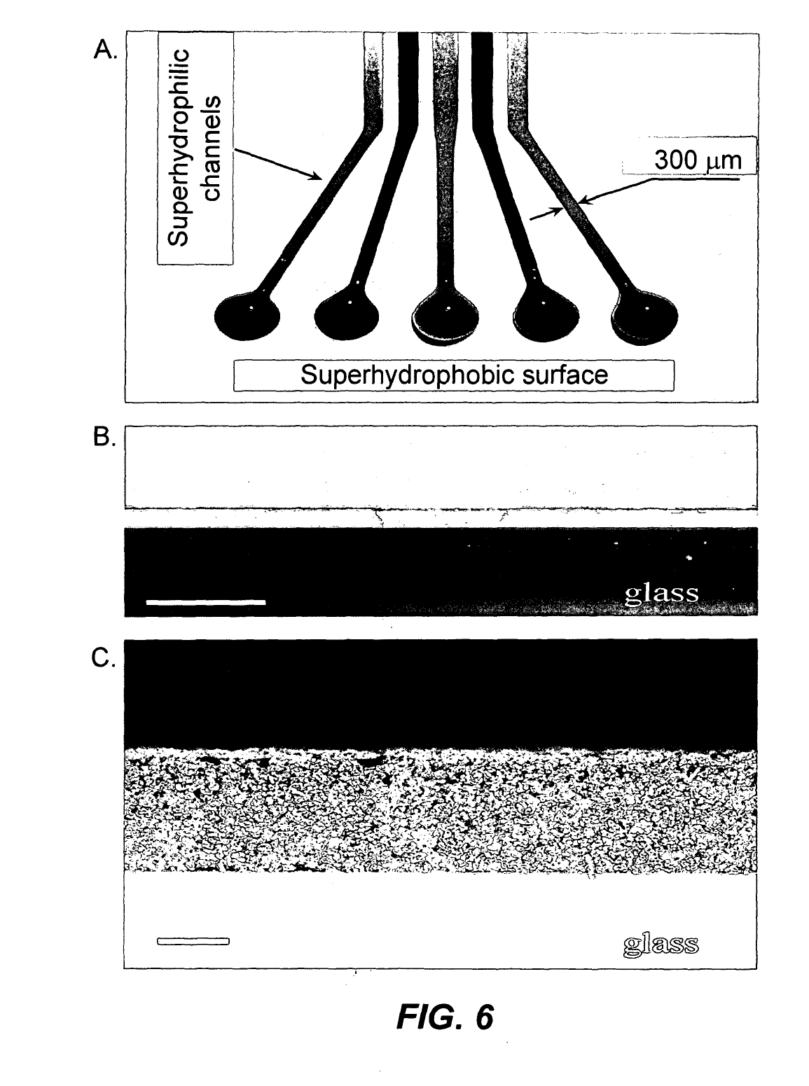

Due to the drastic differences in wettability, superhydrophobic/superhydrophilic patterns can be especially useful in “surface tension confined microfluidics.” As the photografting approach of the present invention is based on photoinitiation, a photomask can be conventionally utilized to generate the required pattern of chemical modification. To demonstrate this application of the present invention, the hydrophilic META was photografted through a quartz photomask onto the surface of a 50 μm-thick superhydrophobic porous BuMA-EDMA layer. FIG. 6a shows five 300 μm-wide surface tension confined microchannels prepared by this method and filled alternatively with aqueous solutions of Rhodamine 6G and Brilliant Blue R dyes using the “reservoirs” grafted at the end of each microchannel. The priming of the channels was achieved solely by capillary forces, i.e., no sophisticated pumping system was necessary. The microchannels were separated from each other with the original superhydrophobic areas. It should be emphasized that the photografting led to the surface modification throughout the three-dimensional porous structure (FIG. 6c). This important specifics was confirmed by filling a 200 μm-wide microchannel with an aqueous solution of Rhodamine 6G and by observing the cross-section of the channel under optical microscope (FIG. 6b).

It should be noted that the manufacture of this five-channel microfluidic device is a single-step process that takes only about 25 minutes to complete. This example clearly demonstrates the great capability of the superhydrophobic surfaces for implementations in microfluidics. The size of the superhydrophobic/superhydrophilic pattern is only limited by the photomask and can be easily both decreased and increased. The latter may be important for the implementation of such patterns e.g. in colorimetric bioassays in which the channels should be large enough to monitor the result with a naked eye.

### REFERENCES

Reference to one or more of the following publications may provide context and/or assist in a better understanding of the invention described and claimed herein:
¹ Barthlott, W. & Neinhuis, C. Purity of the sacred lotus, or escape from contamination in biological surfaces. Planta 202, 1-8 (1997).
² Blossey, R. Self-cleaning surfaces—virtual realities. Nat. Mater. 2, 301-306 (2003).
³ Bravo, J., Zhai, L., Wu, Z. Z., Cohen, R. E., & Rubner, M. F. Transparent superhydrophobic films based on silica nanoparticles. Langmuir 23, 7293-7298 (2007).
⁴ Cassie, A. B. D., Baxter, S., &. Wettability of porous surfaces. Trans. Faraday Soc. 40, 546-551 (1944).
⁵ Eeltink, S., Geiser, L., Svec, F., & Frechet, J. M. J. Optimization of the porous structure and polarity of polymethacrylate-based monolithic capillary columns for the LC-MS separation of enzymatic digests. Journal of Separation Science 30, 2814-2820 (2007).
⁶ Feng, X. J. & Jiang, L. Design and creation of superwetting/antiwetting surfaces. Adv. Mater. 18, 3063-3078 (2006).
⁷ Gao, L. & McCarthy, T. J. How Wenzel and Cassie were wrong. Langmuir 23, 3762-3765 (2007).
⁸ Garrod, R. P., et al. Mimicking a Stenocara beetle's back for microcondensation using plasmachemical patterned superhydrophobic-superhydrophilic surfaces. Langmuir 23, 689-693 (2007).
⁹ Gau, H., Herminghaus, S., Lenz, P., & Lipowsky, R. Liquid Morphologies on Structured Surfaces: From Microchannels to Microchips. Science 283, 46-49 (1999).
¹⁰ Lam, P., Wynne, K. J., & Wnek, G. E. Surface-tension-confined microfluidics. Langmuir 18, 948-951 (2002).
¹¹ Li, X. M., Reinhoudt, D., & Crego-Calama, M. What do we need for a superhydrophobic surface? A review on the recent progress in the preparation of superhydrophobic surfaces. Chem. Soc. Revs. 36, 1350-1368 (2007).
¹² Liu, H., Feng, L., Zhai, J., Jiang, L., & Zhu, D. B. Reversible wettability of a chemical vapor deposition prepared ZnO film between superhydrophobicity and superhydrophilicity. Langmuir 20, 5659-5661 (2004).
¹³ Pastine, S., et al. A facile and patternable method for the surface modification of carbon nanotube forests using perfluoroarylazides. J. Am. Chem. Soc. 130, ASAP (2008).
¹⁴ Premstaller, A., Oberacher, H., & Huber, C. G. High-performance liquid chromatography-electrospray ionization mass spectrometry of single- and double-stranded nucleic acids using monolithic capillary columns. Anal. Chem. 72, 4386-4393 (2000).
¹⁵ Ranby, B. Surface modification of polymers by photoinitiated graft polymerization. Macromol. Chem., Macromol. Symp. 63, 55-67 (1992).
¹⁶ Ranby, B., Yang, W. T., & Tretinnikov, O. Surface photografting of polymer fibers, films and sheets. Nucl. Instrum. Methods Phys. Res., Sect. B 151, 301-305 (1999).
¹⁷ Rohr, T., Hilder, E. F., Donovan, J. J., Svec, F., & Frechet, J. M. J. Photografting and the Control of Surface Chemistry in Three-Dimensional Porous Polymer Monoliths. Macromolecules 36, 1677-1684 (2003).
¹⁸ Sun, T. L., Feng, L., Gao, X. F., & Jiang, L. Bioinspired surfaces with special wettability. Acc. Chem. Res. 38, 644-652 (2005).
¹⁹ Svec, F. & Huber, C. G. Monolithic materials: promises, challenges, achievements. Anal. Chem. 2101-2107 (2006).
²⁰ Tadanaga, K., Kitamuro, K., Matsuda, A., & Minami, T. Formation of superhydrophobic alumina coating films with high transparency on polymer substrates by the sol-gel method. J. Sol-Gel Sci. Technol. 26, 705-708 (2003).
²¹ Tadanaga, K., Morinaga, J., & Minami, T. Formation of superhydrophobic-superhydrophilic pattern on flowerlike alumina thin film by the sol-gel method. J. Sol-Gel Sci. Technol. 19, 211-214 (2000).
²²Tuteja, A., et al. Designing Superoleophobic Surfaces. Science 318, 1618-1622 (2007).
²³ Yabu, H. & Shimomura, M. Single-Step Fabrication of Transparent Superhydrophobic Porous Polymer Films. Chem. Mater. 17, 5231-5234 (2005).
²⁴ Zhai, L., et al. Patterned superhydrophobic surfaces: toward a synthetic mimic of the namib desert beetle. Nano Lett. 6, 1213-1217 (2006).
²⁵ Zhang, J. L., Huang, W. H., & Han, Y. C. A composite polymer film with both superhydrophobicity and superoleophilicity. Macromolecular Rapid Communications 27, 804-808 (2006).
²⁶ Zhang, X., et al. A transparent and photo-patternable superhydrophobic film. Chem. Commun. 4949-4951 (2007).
²⁷ Zhang, X., Shi, F., Niu, J., Jiang, Y., & Wang, Z. Superhydrophobic surfaces: from structural control to functional application. J. Mater. Chem. 18, 621-633 (2008).
²⁸ Zhao, B., Moore, J. S., & Beebe, D. J. Surface-directed liquid flow inside microchannels. Science 291, 1023-1026 (2001).

### CONCLUSION

A general, facile and inexpensive way for the preparation of superhydrophobic and superhydrophilic materials and surfaces on different substrates of different shapes together with the ability to modify the surface in a patternable way is provided. This enables a significant increase in the number of both scientific and practical applications of the important properties of superhydrophobicity and superhydrophilicity.

Although the foregoing invention has been described in some detail for purposes of clarity of understanding, certain changes and modifications may be practiced within the scope of the appended claims. It should be noted that there are many alternative ways of implementing both the process and compositions of the present invention. Accordingly, the present embodiments are to be considered as illustrative and not restrictive, and the invention is not to be limited to the details given herein.

1. A superhydrophobic material comprising:
an exposed surface comprising a porous intrinsically hydrophobic polymer having a dual micro- and nano-scale roughness.

2. The superhydrophobic material of claim 1, wherein the porous polymer is a free radical polymerization of a polyvinyl crosslinker and monovinyl monomers in the presence of an inert porogen.

3. The superhydrophobic material of claim 2, wherein the polyvinyl crosslinker is selected from the group consisting of alkylene diacrylates, alkylene dimethacrylates, pentaerythritol tetraacrylate, pentaerythritol tetramethacrylate, trimethylopropane acrylate, trimethylopropane methacrylate, divinylbenzene and divinylnaphthalene.

4. The superhydrophobic material of claim 3, wherein the monovinyl monomers are selected from the group consisting of alkyl acrylates, alkyl methacrylates, aryl acrylates, aryl methacrylates, aryl alkyl acrylates, aryl alkyl methacrylates, fluorinated alkyl acrylates, fluorinated alkyl methacrylates, styrene, vinylnaphthalene, vinylanthracene, and derivatives thereof, wherein the alkyl group in each of the alkyl monomers has 4-18 carbon atoms.

5. The superhydrophobic material of claim 4, wherein the inert porogen is selected from the group consisting of aliphatic hydrocarbons, aromatic hydrocarbons, esters, amides, alcohols, ketones, ethers, solutions of soluble polymers, and mixtures thereof.

6. The superhydrophobic material of claim 1, wherein the porous polymer is poly(2,2,3,3,3-pentafluoropropyl methacrylate-co-ethylene dimethacrylate) (PFPMA-EDMA).

7. The superhydrophobic material of claim 1, wherein the porous polymer is poly(styrene-co-divinylbenzene) (ST-DVB).

8. The superhydrophobic material of claim 1, wherein the porous polymer is a monolith.

9. The superhydrophobic material of claim 1, wherein the porous polymer is a powder.

10. The superhydrophobic material of claim 1, wherein the porous polymer is a sheared layer.

11. A superhydrophobic material comprising:
an exposed surface comprising a porous intrinsically hydrophilic polymer having a dual micro- and nano-scale roughness.

12. The superhydrophobic material of claim 11, wherein the porous polymer has concave topographical features comprising interconnected microglobules.

13. The superhydrophobic material of claim 11, wherein the porous polymer is poly(butyl methacrylate-co-ethylene dimethacrylate) (BuMA-EDMA).

14. The superhydrophobic material of claim 11, wherein the porous polymer is selected from the group consisting of a monolith, a powder and a sheared layer.

15. The superhydrophobic material of claim 11, further comprising a substrate on which the superhydrophilic material is disposed thereby forming a composite.

16. The superhydrophobic material of claim 1, wherein the porous polymer is freestanding.

17. The superhydrophobic material of claim 1, further comprising a substrate on which the superhydrophobic material is disposed thereby forming a composite.

18. A superhydrophilic material comprising:
an exposed surface comprising a porous intrinsically hydrophilic polymer having a dual micro- and nano-scale roughness.

19. The superhydrophilic material of claim 18, wherein the porous polymer is a free radical polymerization of a polyvinyl crosslinker and monovinyl monomers in the presence of an inert porogen.

20. The superhydrophilic material of claim 19, wherein the polyvinyl crosslinker is selected from the group consisting of alkylene diacrylates, alkylene dimethacrylates, alkylene diacrylamides, alkylene dimethacrylamides, hydroxyalkylene diacrylates, hydroxyalkylene dimethacrylates, wherein the alkylene group consists of 1-4 carbon atoms, oligoethylene glycol diacrylates, vinyl esters of polycarboxylic acids, pentaerythritol diacrylate, pentaerythritol triacrylate, pentaerythritol dimethacrylate, and pentaerythritol trimethacrylate.

21. The superhydrophilic material of claim 20, wherein the polyvinyl crosslinker is selected from the group consisting of ethylene dimethacrylate and methylene-bis-acrylamide.

22. The superhydrophilic material of claim 20, wherein the monovinyl monomers are selected from the group consisting of alkyl vinylacetate, vinylpyrrolidone, acrylic acid, methacrylic acid, methacrylamide, acrylamide, alkyl derivatives of methacrylamide, alkyl derivatives of acrylamide, wherein the alkylene group consists of 1-4 carbon atoms, hydroxyalkyl acrylates and acrylamides, hydroxyalkyl methacrylates and methacrylamides, oligoethylene glycol acrylates and oligoethylene glycol methacrylates, potassium 3-sulfopropyl acrylate, potassium 3-sulfopropyl methacrylate, 2-acryloamido-2-methyl-1-propanesulfonic acid, 2-acrylamidoglycolic acid, [2-(methacryloyloxy)ethyl]trimethylammonium chloride, and N-[3-(dimethylamino)propyl]methacrylamide.

23. The superhydrophilic material of claim 22, wherein the monovinyl monomers are selected from the group consisting of 2-hydroxyethyl methacrylate, decaethylene glycol methacrylate, N-isopropylacrylamide, and acrylamide.

24. The superhydrophilic material of claim 22, wherein the inert porogen is selected from the group consisting of aliphatic hydrocarbons, aromatic hydrocarbons, esters, amides, alcohols, ketones, ethers, solutions of soluble polymers, water, and mixtures thereof.

25. The superhydrophilic material of claim 18, wherein the porous polymer is poly(2-hydroxyethyl methacrylate-co-ethylene dimethacrylate) (HEMA-EDMA).

26. The superhydrophilic material of, claim 18 wherein the porous polymer is selected from the group consisting of a monolith, a powder and a sheared layer.

27. (canceled)

28. (canceled)

29. The superhydrophilic material of claim 18 wherein the porous polymer is freestanding.

30. The superhydrophilic material of claim 18 wherein the porous polymer is a surface coating on a substrate.

31. (canceled)

32. A material, comprising:
a porous polymer comprising an exposed surface having intrinsic bulk superhydrophobicity or superhydrophilicity.

33. The material of claim 32, wherein the porous polymer is selected from the group consisting of a monolith, a powder and a sheared layer.

34. (canceled)

35. (canceled)

36. The material of claim 32, further comprising a substrate on which the superhydrophobic or superhydrophilic material is disposed thereby forming a composite.

37. (canceled)

38. (canceled)

39. The material of claim 36, wherein the surface comprises the porous polymer as a powder adhered to the substrate via an adhesion medium.

40. (canceled)

41. The composite article of claim 36, wherein the substrate is selected from the group consisting of glass, metal, plastic, paper, wood, concrete and masonry.

42. The composite article of claim 36, wherein the substrate is selected from the group consisting of a windshield, a glass plate, a metal plate, a metal object and a glove.

43. (canceled)

44. (canceled)

45. (canceled)

46. (canceled)

47. A method of making a porous polymer having bulk superhydrophobicity or superhydrophilicity, comprising:
conducting a free radical polymerization of a polyvinyl crosslinker and monovinyl monomers in the presence of an inert porogen.

48. The method of claim 47, wherein the polymerization is conducted in a mold.

49. The method of claim 47, wherein the polymerization is conducted on a free surface.

50. The method of claim 47, further comprising crushing the porous polymer monolith formed by the polymerization to form a powder.

51. The method of claim 50, further comprising sieving the powder.

52. The material of claim 36, wherein the porous polymer has bulk superhydrophobicity and the substrate is porous.

53. The material of claim 52, wherein the substrate is selected from the group consisting of wire mesh, fritted glass, microporous polymer and filter paper.

54. A composition, comprising:
a superhydrophobic porous polymer surface having bulk superhydrophobicity; and
a hydrophilic monomer photografted to the superhydrophobic porous polymer surface.

55. The composition of claim 54, wherein the photgrafted hydrophilic monomer is patterned to form channels.

56. The composition of claim 55, wherein the superhydrophobic porous polymer surface comprises BuMA-EDMA and the photografted hydrophilic monomer is META.

57. The composition of claim 56, wherein a 50 μm-thick superhydrophobic porous BuMA-EDMA layer is patterned with 300 μm-wide surface tension confined META microchannels.
